(19) United States
(12) Patent Application Publication
(10) Pub. No.: US 2023/0191330 A1
(43) Pub. Date: Jun. 22, 2023

(54) System and Method for Monovalent Ion Purification Using Multi-Pass Nanofiltration With Recirculation

(71) Applicant: Saline Water Conversion Corporation, Al-Jubail (SA)

(72) Inventors: Ahmed Saleh Mohammed ALAMOUDI, Al-Jubail (SA); Mohammed Farooque AYUMANTAKATH, Al-Jubail (SA); Nikolay VOUTCHKOV, Winter Springs, FL (US); Seungwon IHM, Al-Khobar (SA)

(21) Appl. No.: 17/644,819

(22) Filed: Dec. 17, 2021

(51) Int. Cl. B01D 61/02; C02F 1/44; B01D 61/08

(52) U.S. Cl. CPC B01D 61/027; C02F 1/442; B01D 61/08; C02F 2103/08

(57) ABSTRACT

A system and method for increasing the efficiency of a multi-pass nanofiltration system associated with water desalination and mineral extraction. A saline source water is preferably subjected to a first treatment by passage through a first nanofiltration unit, followed by a second treatment by passage through a second nanofiltration unit. At least a portion of the second nanofiltration unit's reject stream is recirculated to the inlet of the first nanofiltration unit, thereby increasing the production of permeate from the first nanofiltration unit, as well as increasing the purity of monovalent ions in the first nanofiltration unit permeate. Further nanofiltration units with one or more recirculated reject streams may be connected in series and/or in parallel with the first and second nanofiltration units.

The present invention relates to design and operation of desalination facilities, and in particular to a system and method for improving water recovery and mineral byproduct production.

### BACKGROUND AND SUMMARY OF THE INVENTION

In the desalination industry, freshwater is produced is various processes which convert seawater, brackish water, etc., into fresh water. For convenience of reference, at most locations herein reference is made to “seawater,” “saline water” or “feedwater” as the source water. These references are not intended to be limiting, as the source water may be any saline water recognized by those of ordinary skill in the art as possible feed water to a desalination facility.

Most saline water sources contain a large number of minerals in the form of dissolved ions. In desalination a driving force is applied to remove the minerals from the seawater by means of thermal energy such as MSF (Multi Stage Flash) and MED (Multiple Effect Distillation) or pressure energy such as reverse osmosis (RO), forward osmosis and membrane distillation, or a hybrid system combined between thermal and membrane systems.

Typical desalination plants also have to manage the concentrated brine discharge remaining after separation of potable water (e.g. water with a total dissolved solids (TDS) level of approximately 300 parts per million (ppm) or less). Direct discharge of the brine in its concentrated form may potentially have an adverse impact on the marine environment. Alternative means for disposal of the concentrated brine are costly, due to the relatively large volume of this byproduct and the need to dispose of it in an environmentally safe manner.

The problems with concentrated brine may be at least partially addressed by extraction of minerals of commercial interest such as sodium, chloride, calcium and magnesium as byproducts which may be used in further applications and/or in to a zero liquid discharge system (membrane or thermal) to minimize environmental impacts. In order to utilize the dissolved ions for various applications, for example using NaCl solution as a raw material for chlor-alkali industry, it is important to increase the content of the ions selected from extraction and beneficial reuse as compared to the other ions in the saline water.

Nanofiltration (NF) is a well-known membrane-based separation method with permeate and retentate output streams (permeate being the output stream containing ions that have passed through the nanofiltration membrane, and retentate being the output stream that contains ions that have not passed through the membrane). Nanofiltration results in different ion rejections depending on the size and charge of the ions and their salt diffusion coefficient in water. In general, NF membranes have relatively higher rejection of multivalent ions and lower rejection on monovalent ions, making NF suitable for selective enhanced separation of monovalent ions where the target monovalent ions have relatively higher concentrations than the multivalent ions in the NF permeate.

Examples of differences in rejection observed in testing are illustrated in Table 1, which classes NF membranes by their respective ion rejection performance with a seawater feed source TDS concentration in the range of 35,000-47,000 ppm at approximately 17 bars of feed pressure. Most of the monovalent ions in the seawater are Sodium (Na+), Chloride (Cl—) and Potassium (K—) ions. Among divalent ions, there typically is a higher rejection of Sulfate (SO4−−) ions such as Calcium (Ca++), Magnesium (Mg++) and Bicarbonate (HCO3−) ions (while bicarbonate (HCO3−) is monovalent, it is included in the divalent portion of Table 1 because its rejection by NF is similar to that of other multivalent ions).

TABLE 1

| | Group A | Group B | Group C |
|---|---|---|---|
| | High | Medium | Low |
| | rejection NF | rejection NF | rejection NF |
| TDS rejection | >45% | 25~45% | <25% |
| Typical monovalent | 35~80% | 15~40% | 5~0% |
| ion rejection** | | | |
| Typical divalent ion | 70~100% | 45~100% | 35~100% |
| rejection*** | | | |
| Sulfate | 96~100% | 96~100% | 95~100% |
| Calcium | 80~98% | 45~90% | 35~70% |
| Magnesium | 88~98% | 80~98% | 70~90% |

Although NF membranes have relatively low rate of rejection of monovalent ions as compared to the higher rejection rate of multivalent ions, Table 1 shows that the purity of monovalent ions in the permeate of the NF system might not be adequate for beneficial use after a single pass through the NF unit, particularly if the target mineral purity level is 98% or more. Accordingly, because the ion rejection rate of divalent ions is not always close to 100%, when the required minimum purity of the monovalent ions of interest is high, or the allowable “impurity level” of certain multivalent ions is very low, a single pass NF system may not be sufficient to obtain the desired product quality. Thus, additional separation processing in two or more passes may be needed to enhance the purity of the monovalent ions and/or lower the content of the multivalent ions in the NF permeate.

However, when two or more passes are considered, the total recovery of the NF system drops sharply. For example, if the recovery (R) of single pass is 70%, the recovery of a two pass NF system with R=70% of each pass will result in total R of only 49%. Alternatively, in order to maintain the same final NF permeate flow rate, the system would have to be designed for a 43% larger seawater feed to the first NF pass.

The present invention addresses these and other problems, providing for a two or more-unit NF system with recirculation of the NF retentate rejected from the second and/or subsequent passes to the feed entering the first NF unit. The recirculation of the second and/or subsequent NF reject both increases the overall recovery and increases the purity of monovalent ions in the final NF permeate.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of a nanofiltration system for production of water and high-purity mineral streams.

FIG. 2 is a schematic illustration of an embodiment of a nanofiltration system in accordance with the present invention.

FIGS. 3-5 are schematic illustrations of further nanofiltration system embodiments in accordance with the present invention.

### DETAILED DESCRIPTION

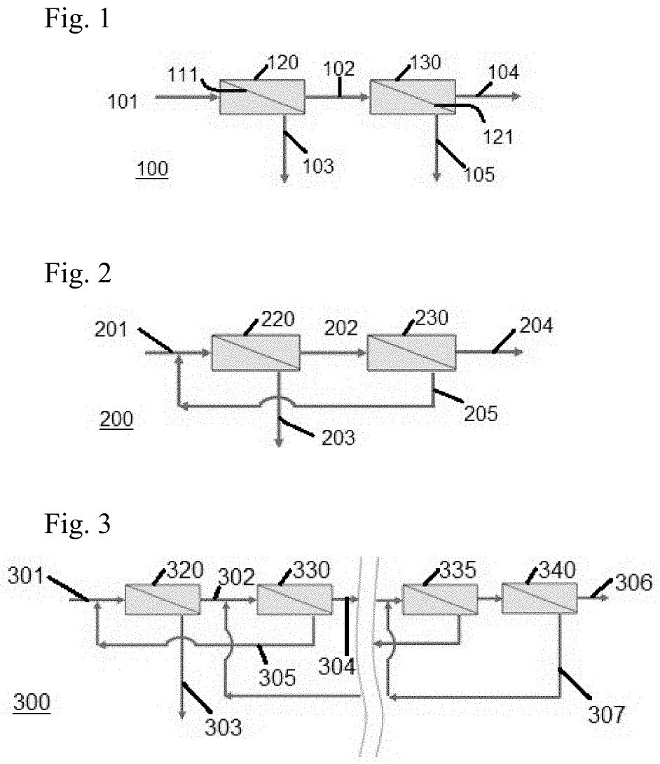

In the following descriptions, calculations of mass and ion balances in the FIG. 1 and FIG. 2 embodiments are based on an example 1000 ton seawater feed flow.

A simplified schematic illustration of an embodiment of a conventional two-pass nanofiltration system 100 is shown in FIG. 1. In this simplified illustration, the source saline water 101 received at the inlet 101 in a first nanofiltration unit 120 (NF #1) is seawater with a TDS of approximately 45,000 ppm, and the individual nanofiltration system recovery fraction (R) is 70%. As also shown in the first column of Table 2, below, the seawater stream feed TDS includes chloride (Cl⁻) at 24,904 ppm, sodium (Na⁺) at 13,863 ppm, sulfate (SO₄⁻²) at 3,414 ppm, magnesium (Mg⁺²) at 1,657 ppm, calcium (Ca⁺²) at 502 ppm, potassium (K⁺) at 482 ppm, and bicarbonate (HCO₃⁻) at 171 ppm.

The effluents from the first nanofiltration unit 120 include a portion of the saline water 101 which entered the nanofiltration unit 120 and passed through the separation membrane 111 (i.e., NF #1 permeate stream 102), and a portion of the saline water 101 which does not pass through the nanofiltration membrane 111 (i.e., NF #1 reject stream 103). As shown in the second column of Table 1 the permeate NF #1 permeate water 102 yield is 70% (i.e., 700 tons), with the NF #1 permeate stream concentrations being TDS at 34,916 ppm, Cl⁻ at 21,963 ppm, Na⁺ at 12,028 ppm, SO₄⁻² at 35 ppm, Mg⁻² at 228 ppm, Ca⁺² at 171 ppm, K— at 425 ppm, HCO₃₋. at 66 ppm. The NF #1 reject stream 103, at 300 tons, has higher concentrations of dissolved solids as shown in the third column of Table 2, with the TDS of the NF #1 reject stream 103 having increased to 68,505 ppm and corresponding increases in the constituents, i.e., Cl⁻ at 31,766 ppm, Na⁺ at 18,145 ppm, SO₄⁻², at 11,299 ppm, Mg⁺² at 4,990 ppm, Ca⁺² at 1,276 ppm, K⁺ at 615 ppm, and 415 at ppm HCO₃⁻ at 415 ppm.

The NF #1 reject stream 103 is removed from the nanofiltration system 100 for subsequent further processing and/or disposal in an environmentally appropriate manner. The NF #1 product stream 102 is introduced to a second nanofiltration unit 130 as the NF #2 feed stream (the NF #2 feed stream contains the same concentrations as the NF #1 permeate stream). Similar to the first nanofiltration unit 120, the second nanofiltration unit 130 includes a separation membrane 121. The fourth column of Table 1 lists the NF #2 permeate stream 104 concentrations, with a TDS at 30,295 ppm, Cl⁻ at 19,370 ppm, Na⁺ at 10,435 ppm, SO₄⁻² at 0 ppm, Mg⁺² at 32 ppm, Ca⁺² at 58 ppm, K⁺ at 375 ppm, and HCO₃⁻ at 25 ppm. The NF #2 retentate discharge (reject) stream 105 concentrations shown in Table 1, column 5 are TDS at 45,698 ppm, Cl⁻ at 28,025 ppm, Na⁺ at 15,743 ppm, SO₄⁻² at 117 ppm, Mg⁺² at 688 ppm, Ca⁺² 433 ppm, K⁺ at 542 ppm, and HCO₃⁻ at 160 ppm.

TABLE 2
Stream compositions in the FIG. 1 two-pass NF arrangement.

| | | | | NF#2 | | |
|---|---|---|---|---|---|---|
| | | NF#1 | | Feed | NF#2 | |
| | NF#1 | Permeate | NF#1 | (=NF#1 | Permeate | NF#2 |
| (unit: ppm) | Feed | (R = 70%) | Reject | Permeate) | (R = 70%) | Reject |
| Flow Fraction | 100% | 70% | 30% | 70% | 49% (overall) | 21% |
| TDS | 45,000 | 34,916 | 68,505 | 34,916 | 30,295 | 45,698 |
| Cl⁻ | 24,904 | 21,963 | 31,766 | 21,963 | 19,370 | 28,015 |
| Na⁺ | 13,863 | 12,028 | 18,145 | 12,028 | 10,435 | 15,743 |
| SO₄⁻² | 3,414 | 35 | 11,299 | 35 | 0 | 117 |
| Mg⁺² | 1,657 | 228 | 4,990 | 228 | 32 | 688 |
| Ca⁺² | 502 | 171 | 1,276 | 171 | 58 | 433 |
| K⁺ | 482 | 425 | 615 | 425 | 375 | 542 |
| HCO₃⁻ | 171 | 66 | 415 | 66 | 25 | 160 |
| Mg/TDS | 3.683% | 0.654% | N/A | 0.654% | 0.104% | 1.506% |
| CaSO₄ | N/A | N/A | 161% | N/A | N/A | N/A |
| saturation | | | | | | |

As the source saline water is processed through the conventional nanofiltration system's first NF subsystem (NF #1 120), the impurity index (Mg/TDS) is lowered from 3.683% to 0.654%, with the impurity level being further lowered to 0.104% after processing through the second NF unit (NF #2 130), as shown in the fifth column of Table 1 (NF #2 permeate). However, the overall recovery of the whole NF system is reduced to only 49%, which means a larger intake system will be needed to meet desired production targets.

FIG. 2 shows an embodiment 200 of the present invention in which substantial system performance improvements are achieved. At least a portion of the reject stream 205 from the second nanofiltration unit 230 is recirculated into the saline water stream 201 entering the second nan-filtration unit 220 (in this embodiment, 100% of the NF #2 reject stream 205).

Among the advantages resulting from recirculation of the highly concentrated brine of reject stream 205 into the feed stream 201 are increasing of the overall recovery of the nanofiltration system 200 and enhanced concentration of monovalent ions in the NF #1 reject stream 203. Moreover, this recirculation process increases energy efficiency, as little to no additional energy is required to significantly raise the pressure of the recirculated NF #2 reject stream 204.

Tables 3 illustrates the improved concentration performance with the present invention's reject stream recirculation, using a specific example in which the FIG. 2 NF #1 feed stream 201's inlet flow is increased by approximately one-quarter by the introduction of the NF #2 reject stream 205 into the NF #1 feed stream 201.

As a consequence of the NF #2 reject recirculation, the feed flow rate of NF #1 220 increases, which in turn increases the production of permeate from NF #1 220. The recirculation of the NF #2 reject stream 205 also can lead to a desirable increase the concentration of monovalent ions in the NF #2 permeate stream 204 relative to the concentration of multivalent ions. thereby increasing the purity of the final permeate and its beneficial use for target applications.

TABLE 3
Feed flow rate and ion concentration at NF #1 feed with NF #2 reject recirculation.

| | | NF#1 | | | NF#2 | | |
|---|---|---|---|---|---|---|---|
| | | Feed | NF#1 | | Feed | NF#2 | |
| | NF#1 | (with NF#2 | Permeate | NF#1 | (=NF#1 | Permeate | NF#2 |
| (unit: ppm) | Feed | reject) | (R = 70%) | Reject | Permeate) | (R = 70%) | Reject |
| Flow Fraction | 100% | 126.6% | 88.6% | 38% | 88.6% | 62% | 26.6% |
| TDS | 45,000 | 45,442 | 36,090 | 67,265 | 36,090 | 31,357 | 47,134 |
| Cl⁻ | 24,904 | 25,759 | 22,717 | 32,857 | 22,717 | 20,035 | 28,977 |
| Na⁺ | 13,863 | 14,381 | 12,477 | 18,824 | 12,477 | 10,825 | 16,332 |
| SO₄⁻⁻ | 3,414 | 2,717 | 28 | 8,990 | 28 | 0 | 93 |
| Mg⁺⁺ | 1,657 | 1,434 | 198 | 4,319 | 198 | 27 | 595 |
| Ca⁺⁺ | 502 | 484 | 165 | 1,231 | 165 | 56 | 418 |
| K⁺ | 482 | 499 | 440 | 636 | 440 | 388 | 561 |
| HCO₃⁻ | 171 | 168 | 65 | 409 | 65 | 25 | 158 |
| Mg/TDS | 3.683% | 3.156% | 0.548% | N/A | 0.548% | 0.087% | 1.263% |
| CaSO⁴ | N/A | N/A | N/A | 128% | N/A | N/A | N/A |
| saturation | | | | | | | |

The effects of the improved system in the FIG. 2 embodiment may be seen in Table 3, which shows the changes in NF #1 220 feed flow rate and the ion concentrations in the NF #1 feed stream for varying amounts of NF #2 reject stream 205 recirculation. A higher flow feed rate to NF #1 220 results in higher overall recovery because the same saline source water flow rate is augmented by the recirculated flow, increasing the amount of water available to pass through the NF membrane. For example, a higher recovery up to a 33.3% may result from a 33.3% higher feed flow rate to the NF #1 220, depending on the recovery characteristics of the particular type of nanofiltration unit of NF #1.

The higher overall recovery may also be accompanied by an increase in the content of monovalent ions and a relatively lower amount of increase in divalent ion content (content=flow rate times concentration). This is because the modified NF #1 feed stream is a mixture of the fixed flow rate of saline water 201 and the recirculation flow of NF #2 reject stream 205. The ion concentration in the NF #1 feed stream therefore is a function of the efficiencies of the nanofiltration units NF #1 220 and NF #2 230 (i.e., the ion rejection rates as well as the recovery rates) that, combined, result in the ion concentrations of the NF #2 reject stream 205. Thus, because the ion rejection rate of monovalent ions of a typical NF membrane is lower than the rejection rate of multivalent ions, the ratio of multivalent ion concentration to monovalent ion concentration (a measure of impurity of the permeate in terms of content of multivalent ions) in the NF #1 feed stream will be lower with the present invention's NF #2 reject stream 205 recirculation.

This effect is discernable in Table 4, which illustrates the relative ion concentrations in the NF #1 feed stream, and associated relative ion rejection and recovery rates for various amounts of NF #2 reject stream recirculation as compared to no recirculation (i.e., NF #1 feed=1.000). Table 4 shows that ions which are rejected to a greater degree by nanofiltration membranes (typically, multivalent ions) are concentrated less (left columns), and ions rejected poorly by the NF membranes (typically monovalent ions) are concentrated at a relatively higher rate (right columns). Therefore, the ratio of multivalent ion concentration to monovalent ion concentration in the permeate streams will be proportionally reduced. When the resultant ion concentration in the NF #1 feed is less than 1,000 ppm, then there is benefit to recirculation (in Table 4, the underlined entries). For example, using the example of Table 2 of, R_individual=70% and rejection of Mg=between 80% and 90%, from Table 3, we can find the relative concentration is 0.845˜0.898 (i.e., less than 1.000), and thus recirculation is desirable. The advantages of the present invention are particularly manifested when the recovery of individual NF subsystems (R) is 50% or lower, and, when R is greater than 50%, the interested ion rejection of an individual NF subsystem (Rej) is between approximately Rej (in %)≥1.4×R (%)−40%.

Accordingly, selection of the amount of recirculation may be used to alter the concentrations in the respective permeate and reject streams to tailor the present invention's operations to targeted stream output concentrations.

TABLE 4
Feed flow rate and ion concentration at NF #1 feed with NF #2 reject recirculation.

| Recovery of | Flow | | | | | | | | | | | |
|---|---|---|---|---|---|---|---|---|---|---|---|---|
| Individual | Rate of | Ion Rejection Rate of Individual NF Sub-system | | | | | | | | | | |
| NF | NF#1 | 100% | 90% | 80% | 70% | 60% | 50% | 40% | 30% | 20% | 10% | 0% |
| Subsystem | Feed* | Ion Concentration in NF#1 Feed* | | | | | | | | | | |
| 0% | 1.000 | 1.000 | 1.000 | 1.000 | 1.000 | 1.000 | 1.000 | 1.000 | 1.000 | 1.000 | 1.000 | 1.000 |
| 10% | 1.099 | 0.910 | 0.919 | 0.928 | 0.937 | 0.946 | 0.955 | 0.964 | 0.973 | 0.982 | 0.991 | 1.000 |
| 20% | 1.190 | 0.840 | 0.857 | 0.874 | 0.890 | 0.907 | 0.923 | 0.939 | 0.955 | 0.970 | 0.985 | 1.000 |
| 30% | 1.266 | 0.790 | 0.814 | 0.837 | 0.860 | 0.883 | 0.905 | 0.927 | 0.947 | 0.966 | 0.984 | 1.000 |
| 40% | 1.316 | 0.760 | 0.790 | 0.820 | 0.850 | 0.878 | 0.905 | 0.930 | 0.952 | 0.971 | 0.988 | 1.000 |
| 50% | 1.333 | 0.750 | 0.787 | 0.824 | 0.860 | 0.893 | 0.923 | 0.949 | 0.971 | 0.987 | 0.997 | 1.000 |
| 60% | 1.316 | 0.760 | 0.805 | 0.850 | 0.892 | 0.930 | 0.962 | 0.988 | 1.005 | 1.013 | 1.011 | 1.000 |
| 70% | 1.266 | 0.790 | 0.845 | 0.898 | 0.947 | 0.989 | 1.023 | 1.044 | 1.053 | 1.048 | 1.030 | 1.000 |
| 80% | 1.190 | 0.840 | 0.907 | 0.970 | 1.027 | 1.074 | 1.105 | 1.119 | 1.115 | 1.091 | 1.052 | 1.000 |
| 90% | 1.099 | 0.910 | 0.991 | 1.068 | 1.133 | 1.182 | 1.209 | 1.211 | 1.187 | 1.140 | 1.076 | 1.000 |
| 100% | 1.000 | 1.000 | 1.099 | 1.190 | 1.266 | 1.316 | 1.333 | 1.316 | 1.266 | 1.190 | 1.099 | 1.000 |

The increase in overall recovery achieved by the present invention also permits cost and energy efficiency improvements. For example, the recirculation of the NF #2 reject stream 205 may permit the size of the seawater intake and pumping station to be reduced. Further, because the reject stream 205 from NF #2 is typically pressurized, the recirculation of the NF #2 reject stream 205 may require little or no boosting of its pressure to be introduced into the seawater feed stream 201, where the feed pressure to NF #1 220 is lower than the feed pressure to NF #2 230. Thus, the present invention's NF #2 recirculation approach recovers pressure energy in the NF #2 reject stream 205 to increase system efficiency.

The amount of benefit from the present invention is dependent on the specific recovery and ion rejection capacities of the particular NF subsystems, which in turn are a function of NF membrane type and operating conditions. Such selective concentration of desirable ions allows for designing the NF system of the present invention in a manner that it suitable for a large number of practical applications. For example, Table 5 illustrates the results of testing of various nanofiltration units, which were found to fall within three broad categories based on their separation performance:

TABLE 5
Classification of sample NF membranes depending on ion rejection.*

| | Group A | Group B | Group C |
|---|---|---|---|
| | High | Medium | Low |
| | rejection NF | rejection NF | rejection NF |
| TDS rejection | >45% | 25~45% | <25% |
| Typical monovalent | 35~80% | 15~40% | 5~20% |
| ion rejection** | | | |
| Typical divalent ion | 70~100% | 45~100% | 35~100% |
| rejection*** | | | |
| Sulfate | 96~100% | 96~100% | 95~100% |
| Calcium | 80~98% | 45~90% | 35~70% |
| Magnesium | 88~98% | 80~98% | 70~90% |

*Based on pilot test data from NF systems with 4 membrane elements in series. Feed source was seawater with a TDS of 35,000~47,000 ppm, and the classification of groups A, B and C was based on TDS rejection of 4-element NF membrane system at about 17.2 bar feed pressure.
**Primarily Sodium (Na⁺), Chloride (Cl⁻) and Potassium (K⁻) ions in seawater.
***Typically higher rejection for Sulfate (SO₄⁻²) ion compared to Calcium (Ca⁺²), Magnesium (Mg⁺²) and Bicarbonate (HCO₃⁻) ions. Bicarbonate (HCO₃⁻) is monovalent, but it is exceptionally considered in this row because its rejection by NF is similar to that of other multivalent ions.

The highly concentrated brine from the NF effluent streams, enriched with sodium and chloride and of low content of calcium and magnesium impurity, may be generated as a raw source material for various industrial uses in which calcium and magnesium impurities must be reduced below an allowable target concentration (e.g., such as chlora-alkali).

The present invention may also be used with reverse osmosis and brine concentrator systems installed downstream of the present invention's NF subsystem arrangements. As most of RO and brine concentrator systems remove both the monovalent and the divalent ions with similar high rejection rates from the NF permeate, it is important to minimize the content of impurities in the NF permeate to be fed to these downstream subsystems, in order to minimize these impurities in the concentrated brine and minimize further processing costs (e.g., further brine purification) before the brine is suitable for use in other industrial production processes. In the example of chlor-alkali industry, magnesium is considered the main impurity that requires removal before the use of the brine in the downstream industrial chemical production process, and therefore minimization of this ion in the NF permeate minimizes further purification needs.

The present invention is not limited to the use of only two nanofiltration units, but may include multiple nanofiltration units arranged with one or more of the downstream reject streams being recirculated to the first nanofiltration inlet and/or to the inlets of one or more upstream nanofiltration units, depending on the target permeate stream quality and/or quantity targets, target reject stream quality and/or quantity targets, and other factors such as cost and suitability of the component arrangements to a particular installation environment.

For example, in the FIG. 3 embodiment 300, multiple nanofiltration units are arranged with the first two units 320, 330 being arranged in the manner shown in FIG. 2, with the recirculation of the NF #2 reject stream 305 to the inlet of the NF #1 unit 320. Further nanofiltration units are arranged downstream of NF #2 330, out to n−1 and n units 335, 340. In this embodiment, at least a portion of each of the downstream nanofiltration units' reject streams is recirculated to the immediately upstream nanofiltration unit (for example, reject stream 407 from the NF #n nanofiltration unit 340 is recirculated to the inlet of the n−1 nanofiltration unit 335.

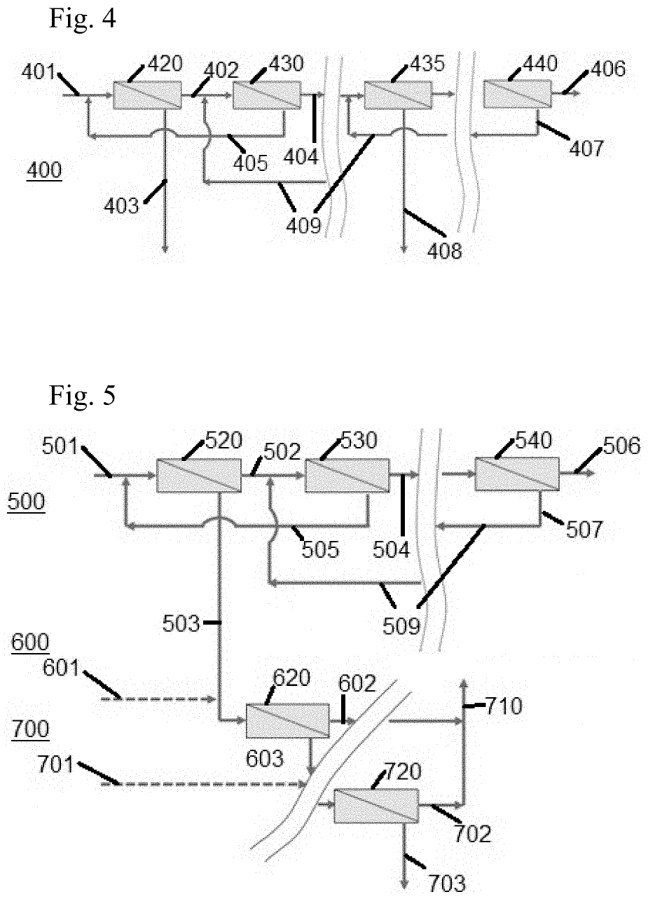

The recirculation of reject streams to solely the immediately upstream nanofiltration unit is not required, and other recirculation routes or combination of routes are possible. For example, FIG. 4 shows another embodiment 400 in which the reject streams 408 from one or more intermediate nanofiltration units NF #i 435 are diverted from the system for subsequent treatment or use, for example, where a particular nanofiltration unit's reject stream ion concentrations suit a particular industrial application, while other reject streams 409 are recirculated to upstream nanofiltration units. This arrangement may be in particular desirable if one or more of the nanofiltration units is constructed with a separation membrane having different selectively for ions than in others of the nanofiltration units.

For example, assuming that a first type of nanofiltration unit (“NF type-A”) rejects less of certain multivalent ions (“Z” ions) relative to a second type of nanofiltration unit (NF type-B”), i.e., higher ionic rejection of Z ions for NF type-B than type-A), a system may use a NF type-A unit for the initial pass(es) in an NF #1 to #i−1 sub-system, and use an NF type-B unit for the downstream passes (i.e., NF #i+1 to n sub-system). In such a system the NF #1 unit reject stream would have higher purity of other multivalent ions, but not the multivalent Z ions, while the NF #i unit reject stream would have higher purity of multivalent Z ions (other multivalent ions having are already removed by the upstream nanofiltration units. Thus, multivalent ions Z may be selectively separated by appropriate choice and arrangement of separation membranes. Similarly, appropriate choices would allow separation of two Depending on the NF membrane types and their ion rejection characteristics, separation of more than two types of multivalent ions.

Another embodiment of the present invention is shown in FIG. 5. In this arrangement of n nanofiltration units in m nanofiltration branches 500, 600, 700, the NF #1 reject stream 503 is routed a separate one of the m branches, specifically in this example to the inlet of a first nanofiltration unit 620. Preferably the saline water 601, 701 being fed to the branches 600, 700 with a lower salinity than the source saline water 501, for example, a partially purified stream from another process or another nanofiltration branch (alternatively, the reject stream 503 from the nanofiltration unit 520 may be routed to the inlet of a further downstream nanofiltration unit in an m branch nanofiltration train). This results in the ability to tailor the product streams to suit downstream applications. For example, depending on the concentrations of ions in the NF #1 reject stream 503 and the ion content saline water 601 (preferably water with a lower salinity than the source saline water 501, for example, a partially purified stream from another process or another nanofiltration branch) being fed to the inlet of nanofiltration unit 620, specific ions may be selectively further separated to increase the concentration of desired monovalent ions in the branch's final permeate product stream and/or generation of a nanofiltration product enriched in multivalent ions beyond that otherwise attainable without the addition of the NF #1 reject stream 503.

With the combination of nanofiltration unit types and arrangements typified by FIG. 5, more than one product stream may be obtained from the saline source water, for example, a nanofiltration process reject stream with higher concentration of multivalent ions such as calcium and magnesium while minimizing monovalent ions such as sodium and chloride, and a final permeate stream enriched in monovalent ions resulting from combination with the lower salinity source water. It is noted that depending on the needs of a particular application, at least a portion of downstream permeate streams may be returned to other nanofiltration units in the same and/or different ones of the m branches to lower the salinity of the feed stream into these nanofiltration units.

An example of method for increasing nanofiltration system performance in accordance with the present invention includes introducing a saline water source stream to the inlet of a first nanofiltration unit, supply of at least a portion of a permeate stream from the first nanofiltration unit to the inlet of a second nanofiltration unit, and recirculation of at least a portion of a reject stream from the second nanofiltration unit to the inlet of the first nanofiltration unit.

The foregoing disclosure has been set forth merely to illustrate the invention and is not intended to be limiting. Because such modifications of the disclosed embodiments incorporating the spirit and substance of the invention may occur to persons skilled in the art, the invention should be construed to include everything within the scope of the appended claims and equivalents thereof.

### LISTING OF REFERENCE LABELS

100, 200, 300, 400, 500 nanofiltration system
101, 201, 301, 401, 501 saline water feed stream
102, 202, 302, 402, 502 nanofiltration unit #1 permeate stream
103, 203, 303, 403, 503 nanofiltration unit #1 reject stream
104, 204, 304, 404, 504 nanofiltration unit #2 permeate stream
105, 205, 305, 405, 505 nanofiltration unit #2 reject stream
111, 121 membrane
120, 220, 320, 420, 520 nanofiltration unit #1 nanofiltration unit
130, 230, 330, 430, 530 nanofiltration unit #2 nanofiltration unit
306, 406, 506 nth nanofiltration unit permeate stream
307, 407, 507 nth nanofiltration unit reject stream
335, 435 intermediate nanofiltration unit
340, 440, 540 nth nanofiltration unit reject stream
409, 509 recirculated intermediate reject streams
601, 701 branch stream saline feed stream
602, 702 branch stream nanofiltration unit #1 permeate stream
603, 703 branch stream nanofiltration unit #1 reject stream
620, 720 branch stream nanofiltration unit #1
710 branch product stream

What is claimed is:

1. A multi-pass nanofiltration system, comprising:
a first nanofiltration unit having an inlet configured to receive a feed water stream, a first permeate outlet configured to output a first permeate stream which has passed through a separation medium of the first nanofiltration unit, the separation medium being configured to selectively separate ions from the feed water stream, and a first reject stream outlet configured to output a first reject stream containing ions which have not passed through the separation medium;
at least one further nanofiltration unit having an inlet configured to receive the first permeate stream, a further permeate outlet configured to output a further permeate stream which has passed through a separation medium of the further nanofiltration unit, and a further reject stream outlet configured to output a further reject stream containing ions which have not passed through the separation medium of the further nanofiltration unit,
wherein at least a portion of the further reject stream is recirculated into the feed water stream received at the first nanofiltration unit inlet.

2. The multi-pass nanofiltration system of claim 1, wherein
the at least one further nanofiltration unit includes a plurality of further nanofiltration units arranged in series,
permeate streams from the plurality of further nanofiltration units are feed streams for a respective next downstream one of the plurality of further nanofiltration units, and
at least a portion of reject streams from the plurality of further nanofiltration units are recirculated into the feed stream of at least one upstream one of the plurality of further nanofiltration units.

3. The multi-pass nanofiltration system of claim 2, wherein
each of the reject streams from the plurality of further nanofiltration units are recirculated into the feed stream of a respective next upstream one of the plurality of further nanofiltration units.

4. The multi-pass nanofiltration system of claim 2, wherein
at least a portion of the reject streams from the plurality of further nanofiltration units are not recirculated into a feed stream of another one of the plurality of further nanofiltration units.

5. The multi-pass nanofiltration system of claim 1, further comprising:
at least one additional plurality of nanofiltration units arranged in series configured to receive the first nanofiltration unit reject stream, the reject stream from at least one of the plurality of further nanofiltration units or both the first nanofiltration unit reject stream and the reject stream from at least one of the plurality of nanofiltration units.

6. The multi-pass nanofiltration system of claim 5, wherein
a first nanofiltration unit of the at least one additional plurality of nanofiltration units is configured to receive the first nanofiltration unit reject stream.

7. The multi-pass nanofiltration system of claim 6, wherein
the at least one additional plurality of nanofiltration units includes at least two additional pluralities of nanofiltration units, each of the at least two additional pluralities of nanofiltration units being arranged in series, and
a reject stream from a first one of the at least two additional pluralities of nanofiltration units is at least a portion of a feed stream of at least one of a second one of the at least two pluralities of additional nanofiltration units.

8. The multi-pass nanofiltration system of claim 4, further comprising:
at least one additional plurality of nanofiltration units arranged in series configured to receive the first nanofiltration unit reject stream, the reject stream from at least one of the plurality of further nanofiltration units or both the first nanofiltration unit reject stream and the reject stream from at least one of the plurality of nanofiltration units.

9. The multi-pass nanofiltration system of claim 8, wherein
a first nanofiltration unit of the at least one additional plurality of nanofiltration units is configured to receive the first nanofiltration unit reject stream.

10. The multi-pass nanofiltration system of claim 9, wherein
the at least one additional plurality of nanofiltration units includes at least two additional pluralities of nanofiltration units, each of the at least two additional pluralities of nanofiltration units being arranged in series, and
a reject stream from a first one of the at least two additional pluralities of nanofiltration units is at least a portion of a feed stream of at least one of a second one of the at least two pluralities of additional nanofiltration units.
